(19) United States
(12) Patent Application Publication
(10) Pub. No.: US 2008/0127687 A1
(43) Pub. Date: Jun. 5, 2008

(54) Locking assembly

(76) Inventor: Rodney Henson, Stockbridge, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(21) Appl. No.: 11/633,230

(22) Filed: Dec. 4, 2006

(51) Int. Cl. E05B 65/06

(52) U.S. Cl. 70/129

(57) ABSTRACT

A locking assembly includes a latch having a bolt, and a plurality of locking members configured to be locked together to lock the bolt, each locking member having an aperture that is closed on an edge by a connecting portion, at least two locks that have shackles and openings, the shackles being movable between an unlocked position, in which the connecting portions can be placed into the openings, and a locked position, in which the shackles extends through the apertures; and a latch shield having an occluding member positioned in the openings along with the connecting portions, and a plurality of blocking members positioned outward of the locks that cannot pass through the openings, such that the occluding member occludes the locking members to prevent cutting the locking members and the blocking members limit movement of the occluding member to prevent removing the occluding member without unlocking the locks.

### BACKGROUND

Objects such as personal property are often secured by placing the objects in an enclosed space and by locking doors into the space, such that ingress into the space is limited. In many cases, a lock is embedded in the door that has a movable bolt. In a locked position the bolt protrudes from the door into an opening in a wall to impede the door from opening. In an unlocked position the bolt is retracted into the door such that the door can be opened. Typically, the bolt is moved between the locked and unlocked positions by turning a key. The key is unique to the lock such that having the key is a prerequisite to accessing the space, although most keys can be easily duplicated.

Securing the space with a lock embedded in the door may be undesirable in cases in which possession of the spaces frequently changes. For example, self-storage or mini-storage facilities provide storage spaces that can be temporarily rented. Typically, a storage space has a latch on an exterior face of the door, and the current renter secures the space by attaching his own lock to the latch. Because each new renter supplies his own lock, the renter can secure the space without changing the lock embedded in the door or taking a chance that the prior possessor duplicated the key. However, because the lock is exposed on the exterior of the door, unauthorized entry to the space can be gained by severing the lock, such as by cutting the lock with a bolt cutter. For this reason, shrouded locks are often used on storage spaces because cutting a shrouded lock with a bolt cutter is very difficult. However, unauthorized entry to the space can still be gained by cutting the latch to separate the fully secured lock from the latch without cutting the lock or opening it with a key. In other words, the tamper resistant characteristics of the shrouded lock are insufficient to secure the space in cases in which the latch is also exposed and can be breached. From the above, it is apparent that a need exists in the industry for a solution to these deficiencies.

### SUMMARY

In one embodiment, a locking assembly includes a latch having a bolt that is movable between an unlocked and a locked position, and a plurality of locking members configured to be locked together to secure the bolt in the locked position. Each locking member may have an aperture that is closed on an edge by a connecting portion of the locking member. The locking assembly may also include at least two locks, each lock having a shackle and an opening. The shackle may be movable between an unlocked position in which the connecting portions of the locking members can be placed into the opening, and a locked position in which the shackle extends through the apertures to lock the locking members together. The locking assembly may also include a latch shield having an occluding member positioned in the openings of the locks along with the connecting portions of the locking members, and a plurality of blocking members positioned outward of the locks. The blocking members may be configured such that the blocking members cannot pass through the openings, such that the occluding member occludes the locking members to prevent cutting the locking members and the blocking members limit movement of the occluding member to prevent removing the occluding member without unlocking the locks.

A latch shield includes an occluding member having a length configured to at least span a distance between two locks and a cross-section configured to substantially fill an opening in each of the locks when positioned in the openings along with locking members of a latch such that the locking members are occluded by the occluding member. A plurality of blocking members may be coupled to the occluding member, the blocking members being configured to be positioned outward of the locks when the occluding member is positioned in the openings of the locks. The blocking members may be shaped to restrict movement of the occluding member such that the occluding member cannot be removed from the openings when the locks are locked.

Other systems, devices, methods, features, and advantages of the disclosed locking assembly will be apparent or will become apparent to one with skill in the art upon examination of the following figures and detailed description. All such additional systems, devices, methods, features, and advantages are intended to be included within the description and are intended to be protected by the accompanying claims.

### BRIEF DESCRIPTION OF THE FIGURES

The present disclosure may be better understood with reference to the following figures. Matching reference numerals designate corresponding parts throughout the figures, and components in the figures are not necessarily to scale.

FIG. 1 is a perspective view of an embodiment of a locking assembly.

FIG. 2 is a perspective view of the locking assembly of FIG. 1, illustrating a latch and a lock of the locking assembly, with a latch shield and another lock removed.

FIG. 3 is a perspective view of an embodiment of a latch shield that can be used in the locking assembly of FIG. 1.

FIG. 4 is a perspective view of the locking assembly of FIG. 1 in the process of being assembled.

### DETAILED DESCRIPTION

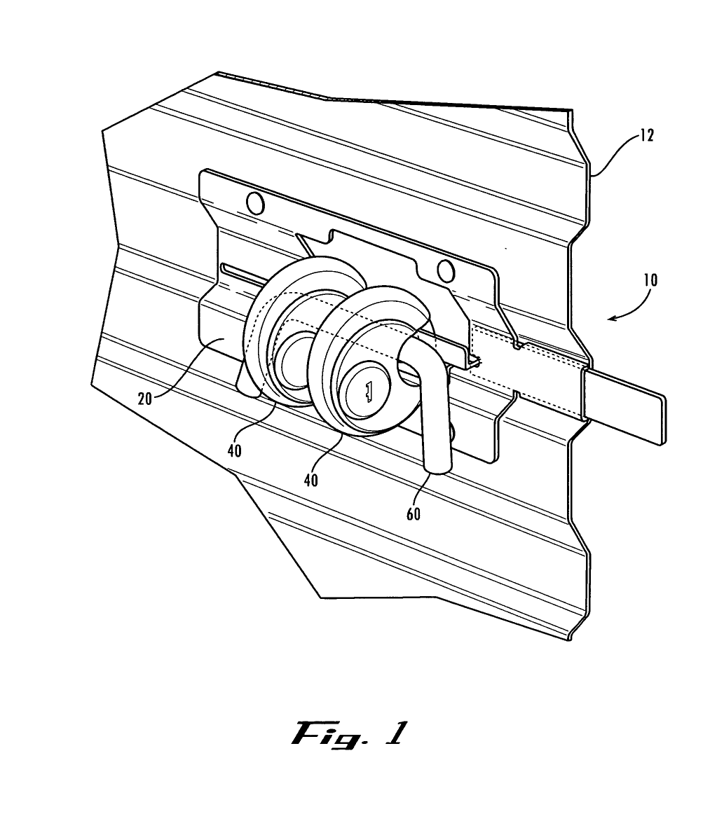

FIG. 1 is a perspective view of an embodiment of a locking assembly 10. The locking assembly 10 includes a latch 20 coupled to a door 12, and a plurality of locks 40 coupled to the latch to secure the latch in a locked position. A latch shield 60 is positioned between the locks 40 and the latch 20 to protect the latch from tampering, as further described below.

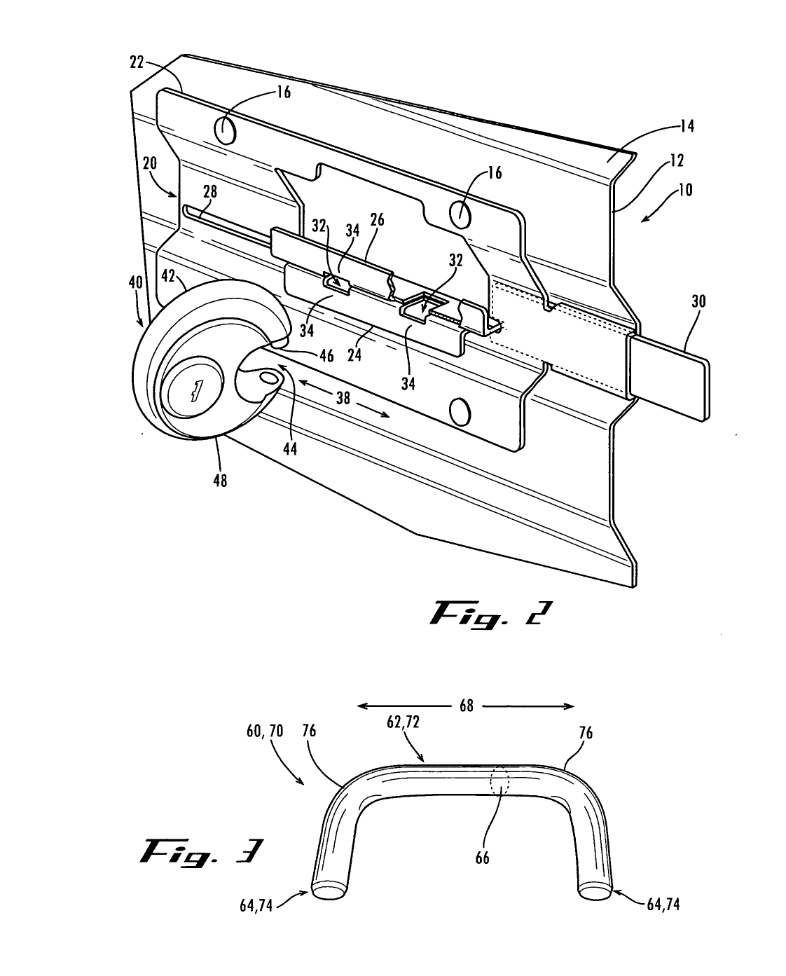

FIG. 2 is a perspective view of the locking assembly 10 of FIG. 1, illustrating the latch 20 and the lock 40 of the locking assembly, with the latch shield 60 and another lock removed. As shown, the latch 20 includes a base 22, a stationary locking-member 24, a movable locking-member 26, a slit 28, and a bolt 30. The base 22 is coupled to an exterior surface 14 of the door 12. As illustrated, the door 12 is a corrugated roll-up door often used in storage facilities, although any door may be used. The base 22 is attached to the door 12 using any type of fastener 16. For example, in the illustrated embodiment the fasteners 16 are bolts.

The stationary locking-member 24 is stationary with respect to the base 22, while the movable locking member 26 is movable with respect to the base between a locked and an unlocked position. The bolt 30 is coupled to the movable locking-member 26, such that movement of the movable locking member along the slit 28 causes concomitant movement of the bolt. When the movable locking member 26 is in the unlocked position, the bolt 30 is retracted into the latch 20. When the movable locking member 26 is in the locked position, the bolt 30 is fully extended from the latch 20. In FIG. 2, the movable locking member 26 is shown in the locked position. The base 22 is positioned on the door 12 such that when the movable locking member 26 is in the locked position, the bolt 30 extends into a cavity (not shown) in a frame (not shown) of the door 12. Therefore, when a user applies force to open the door 12, the bolt 30 contacts the frame of the door and prohibits the door from opening. However, the base 22 is also positioned on the door 12 such that when the movable locking member 26 is in the unlocked position, the bolt 30 retracts from the cavity in the frame of the door, such that the door can freely open.

The latch 20 includes apertures 32 configured to receive a shackle 46 of the lock 40, the apertures being formed through the locking members 24, 26. In the illustrated embodiment, the apertures 32 are arranged on the latch 20 to form two separate sets, and therefore the latch 20 can be used with at most two locks 40. In other embodiments, greater or fewer sets of apertures 32 may be provided on the locking members 24, 26, such that more or fewer locks 40 may be used. Each aperture 32 is adjacent a relatively narrow connecting portion 34 of the locking member 24, 26, the connecting portion closing the aperture along an exterior edge 36 of the locking member. In FIG. 2, the connecting portion 34, adjacent one of the apertures 32 on the movable locking-member 26, has been cut away so that the apertures 32 are clearly visible. The apertures 32 are positioned on the locking members 24, 26 such that the apertures of the set are aligned when the movable locking-member 26 is in the locked position, but are otherwise not aligned. As a result, the lock 40 may be attached when the movable locking member 26 in the locked position, but otherwise cannot be attached. In embodiments in which the base 22 is properly positioned on the door 12, when the bolt 30 is positioned in the cavity to prevent the door from opening, the lock 40 can be attached through the apertures 32 to lock the locking members 24, 26 together about the connecting portions 34. However, when the bolt 30 is not positioned in the cavity, the apertures 32 are not aligned and the locking members 24, 26 cannot be locked together. In some embodiments, the latch 20 may be a latch such as the two or four bolt roll-up door latches manufactured by Chateau Products.

The locking assembly 10 also includes one or more locks 40. Any type and any number of locks 40 may be used, depending on the embodiment. For example, the lock 40 may be a padlock such as a keyed lock or a combination lock. The lock 40 may be a shrouded padlock having a body that is shaped to define a relatively small opening for receiving the objects to be clasped together, such as the disc or biscuit locks of the illustrated embodiments, although other configurations are possible. Because such locks 40 are known, a thorough discussion is omitted here. Briefly, however, the lock 40 includes a body 42 configured to house elements of the lock, an opening 44 formed in the body for receiving the objects to be locked together, and a shackle 46 that is movable between an unlocked and a locked position. In the unlocked position, the shackle 46 is retracted into the body 42 such that the objects can be placed into the opening 44. In the locked position, the shackle 46 bridges the opening 44 from one side of the body 42 to the other, such that the objects are secured together within the opening. To move the shackle 46 between the locked and unlocked positions, a key (not shown) is inserted into a keyhole 48 and is turned, although in other embodiments the lock 40 may be locked and unlocked in other manners.

As mentioned, the illustrated lock 40 is a “shrouded” padlock due to the shape of the opening 44 formed in the body 42. Specifically, the opening 44 is configured such that a relatively smaller portion of the shackle 46 is exposed than with a traditional padlock. In such cases, it may be relatively difficult to remove the lock 40 by cutting through the shackle 46. The difficulty associated with cutting the shackle 46 may be further increased by using a lock 40 having a shackle made from a material such as hardened metal.

In the illustrated embodiment, the body 42 of the lock 40 is a substantially circular metal casing having a diameter of about 2¾ inches. The shackle 46 is a curved cylindrical rod formed from hardened metal having a diameter of about ⅜ inches. The opening 44 formed in the body 42 is substantially semi-circular, having a diameter of about ⅞ inches. For example, the lock 40 may be #40 padlock manufactured by the Master Lock Company of Milwaukee, Wis. In other embodiments, the lock 40 may have other shapes, dimensions, or may be made from other materials, because as mentioned above, any lock can be used in the locking assembly 10.

With reference back to FIG. 1, the latch shield 60 is configured to couple to the locks 40 and to occlude the connecting portions 34 of the locking members 24, 26, such that the connecting portions cannot be cut. Therefore, the shape and size of the latch shield 60 may vary greatly depending on the shape and size of latch 20, and the shape, size, and number of the locks 40.

FIG. 3 is a perspective view of an embodiment of a latch shield 60 that can be used in the locking assembly 10 of FIG. 1. The latch shield 60 includes an occluding member 62 and a plurality of blocking members 64. The occluding member 62 has a cross-section 66 that is sized and shaped to substantially fill the opening 44 of the lock 40. The occluding member 62 has a length 68 that at least spans a distance 38 (FIG. 2) between the sets of apertures 32 on the locking members 24, 26. The blocking members 64 are configured to limit the movement of the occluding member 62, and are coupled to points on the occluding member that enable placing the locks 40 between the blocking members 64, so that the occluding member 62 cannot be removed until the locks are removed. For example, the blocking member 64 may be oriented with respect to the occluding member 62, such that the blocking member cannot be passed through the opening 44 when the occluding member is positioned in the opening. The blocking member may be sized and shaped such that the blocking member cannot fit through the opening regardless of the position of the occluding member.

In the illustrated embodiment the latch shield 60 is a substantially U-shaped bar 70. The U-shaped bar 70 may be a single bar that is bent at both ends. The U-shaped bar 70 has a central occluding portion 72 that forms the occluding member 62, two outward blocking portions 74 that form the blocking members 64, and two connecting curves 76 that connect the outward blocking portions to the central occluding portion.

The central occluding portion 72 is a substantially straight length of tubular bar. The blocking portions 74 are also substantially straight lengths of tubular bar that are substantially perpendicular to the central occluding portion 72. Each of the connecting curves 76 has a radius of curvature such that the connecting curve extends between a connected end of one of the blocking portions 74 and an end of the central occluding portion 72.

The U-shaped bar 70 is formed from a material that is relatively difficult and time consuming to destruct. For example, the U-shaped bar 70 may be formed from a material that cannot be cut with bolt cutters. In at least some embodiments, the U-shaped bar 70 is formed from a hardened metal such as steel, although other materials could be used.

In some embodiments, the U-shaped bar 70 may be a single piece formed by a process such as extrusion. For example, the U-shaped bar 70 may be an extruded tube of hardened metal that is subsequently bent at both ends to form the connecting curves 76 and the two outward blocking portions 74. In such cases, the U-shaped bar 70 may have a cross-section 66 that is substantially uniform. The cross-section 66 may be circular, or the cross-section may have any other shape.

In some embodiments, the U-shaped bar 70 is sized and shaped for use with a latch 20 in which the distance between the apertures 32 on the locking members 24, 26 is about 1.5 to 2 inches, such as the latch shown in the illustrated embodiment. In such an embodiment, the length 68 of the central occluding portion 72 is at least about 3 inches and may be about 4 to 5 inches. In some embodiments, the U-shaped bar 70 is configured for use with a lock 40 having an opening 44 that is substantially semi-circular and has a diameter of about ⅞ inch, such as the locks shown in the illustrated embodiment. In such an embodiment, the U-shaped bar 70 may have a circular cross-section 66 having a diameter of about 0.5 inches, and a radius of curvature of the connecting curves 76 may be between about 0.5 inches to about 2 inches.

The latch shield 60 is illustrated as a U-shaped bar 70, having a circular cross-section 66, because such a bar is relatively easy and inexpensive to produce using an extrusion process, and because such a shape facilitates inserting the latch shield through the lock 40, as further described below. However, in other embodiments, the latch shield 60 may have other shapes, sizes, and configurations. For example, the latch shield 60 need not be a U-shaped bar 70. In some embodiments, the connecting curves 76 are omitted completely, and the blocking members 64 are configured other than as shown in the illustrated embodiment. For example, the blocking members 64 may be masses that are relatively larger than the openings 44 formed in the locks 40, such that the blocking members cannot be passed through the openings. In such case, the blocking members 64 could be spheres, blocks, star-shape, or any other shape configured to block the removal of the occluding member 62. Additionally, the latch shield 60 need not have the circular cross-section 66. For example, the occluding member 62 may have a hollow configured to mate with the connecting portions 34 of the locking members 24, 26, such that the latch shield 60 specifically fits over the connecting portions to further occlude them. The occluding member 62 may also be shaped to fit over the shackle 46 of the lock 40 such that the shackle is occluded from tampering.

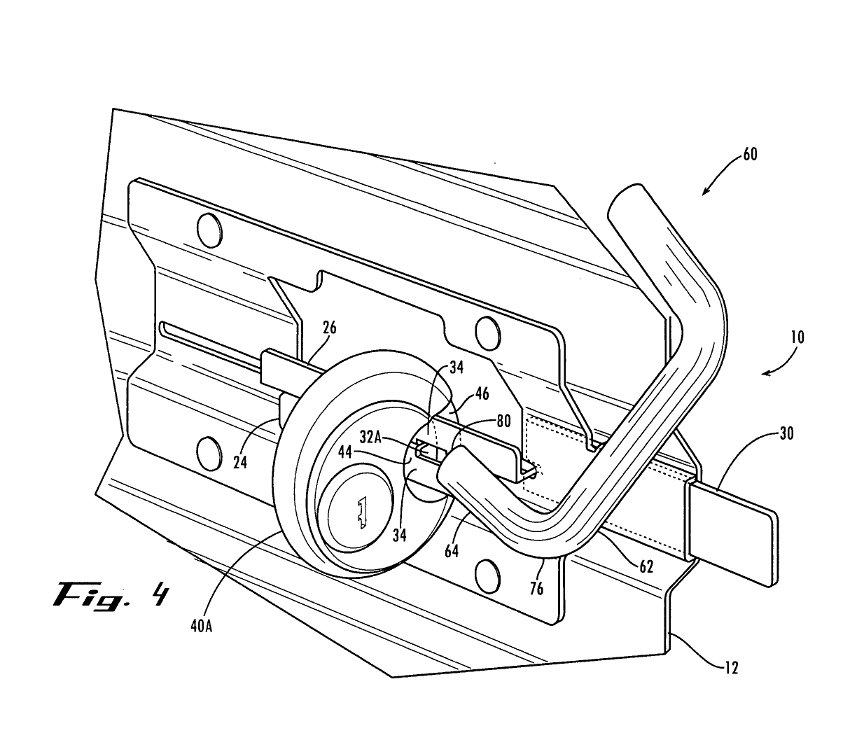

The operation of the latch shield 60 will now be described with reference to FIG. 4, which is a perspective view of the locking assembly 10 of FIG. 1 in the process of being assembled. The door 12 is closed, and the movable locking member 26 of the latch 20 is moved into the closed position such that the bolt 30 of the latch is positioned in the cavity on the door and the apertures 32 on the movable locking member are aligned with the apertures on the stationary locking member 24. In the embodiment shown in FIG. 1, the plurality of locks 40 include two locks, and therefore the apertures 32 include two sets of apertures. In FIG. 4 only lock 40A and a first set of apertures 32A are visible. The first lock 40A is put into position adjacent the first set of apertures 32A, such that the connecting portions 34 that close the apertures are located within the opening 44 of the first lock. The key (not shown) on the first lock 40A is turned to move the shackle 46 on the first lock from the unlocked to the locked position. Once the shackle 46 is in the locked position, the connecting portions 34 that close the first set of apertures 32A are securely clasped within the opening 44 of the first lock 40A. A free end 80 of the latch shield 60 is inserted into the opening 44 of the first lock 40A, and the latch shield is advanced until the blocking member 64 and the connecting curve 76 are positioned on an opposite side of the first lock. The circular cross-section 66 of the latch shield 60 facilitates sliding the blocking member 64 through the opening 44 of the first lock 40A. The second lock 40B (not shown in FIG. 4) is put into position adjacent the second set of apertures 32B (not shown in FIG. 4) in the locking members 24, 26, such that the connecting portions 34 that close the second set of apertures are located within the opening 44 of the second lock 40B. The latch shield 60 is raised into position within the second lock 40B, such that the occluding member 62 of the latch shield 60 is positioned within the opening 44 of second lock 40B. The key on the second lock 40B is turned to move the shackle 46 on the second lock from the unlocked to the locked position. The locking assembly 10 is thus locked into position, as shown in FIG. 1. The bolt 30 of the latch 20 is positioned in the door 12 to prevent the door from opening, and the first and second locks 40A, 40B are locked though the apertures 32 of the locking members 24, 26, such that the movable locking member 26 cannot be moved to retract the bolt. The occluding member 62 of the latch shield 60 is positioned within the openings 44 of the locks 40A, 40B such that the connecting portions 34 on the locking members 24, 26 are occluded and cannot be cut. The blocking members 64 of the latch shield 60 are positioned outward of the first and second locks 40A, 40B, on opposite sides of the first and second locks, such that the latch shield 60 cannot be removed from the locks without opening the locks using the keys. In such a manner, tampering with the locking assembly 10 using, for example, bolt cutters, is relatively difficult because the latch shield 60 occludes the connecting portions 34 of the latch 20.

In other embodiments, the illustrated embodiment of the latch shield 60 may be coupled to the latch 20 and locks 40 in other manners. For example, the latch shield 60 may be held adjacent the latch 20, and the first and second locks 40A, 40B may be placed over the latch shield and locked into place. [However, attaching the latch shield 60 as described above, by locking the first lock 40A into place and passing the latch shield 60 through the first lock 40A, may be less cumbersome for the user.]

While particular embodiments of a locking assembly have been disclosed in detail in the foregoing description and figures for purposes of example, those skilled in the art will understand that variations and modifications may be made without departing from the scope of the disclosure. All such variations and modifications are intended to be included within the scope of the present disclosure, as protected by the following claims.

At least the following is claimed:

1. A locking assembly comprising:
a latch including a bolt that is movable between an unlocked and a locked position, and a plurality of locking members configured to be locked together to secure the bolt in the locked position, each locking member having an aperture that is closed on an edge by a connecting portion of the locking member;
at least one lock, each lock including a shackle and an opening, the shackle being movable between an unlocked position in which the connecting portions of the locking members can be placed into the opening, and a locked position in which the shackle extends through the apertures to lock the locking members together; and
a latch shield that includes an occluding member positioned in the opening of the at least one lock along with the connecting portions of the locking members, and a plurality of blocking members positioned outward of the leeks at least one lock, the blocking members being configured such that the blocking members cannot pass through the opening, such that the occluding member occludes the locking members to prevent cutting the locking members and the blocking members limit movement of the occluding member to prevent removing the occluding member without unlocking the at least one lock.

2. The locking assembly of claim 1, wherein:
the locking assembly includes at least two locks; and
the occluding member has a length that at least spans a distance between the locks and a cross-section that is configured to substantially fill the opening in each of the locks when positioned in the openings along with the connecting portions on the locking members.

3. The locking assembly of claim 2, wherein the latch shield is a U-shaped bar.

4. The locking assembly of claim 3, wherein the U-shaped bar includes a central occluding portion that forms the occluding member, two outward blocking portions that form the blocking members, and two connecting curves that connect the outward blocking portions to the central occluding portion.

5. The locking assembly of claim 4, wherein the central occluding portion is a substantially straight length of tubular bar, and the blocking portions are substantially straight lengths of tubular bar that are substantially perpendicular to the central occluding portion.

6. The locking assembly of claim 4, wherein the central occluding portion has:
a circular cross-section having a diameter of about 0.5 inches, such that the central occluding portion is configured to substantially fill a ⅞ semi-circular opening of a shrouded padlock when placed within the opening along with the connecting portions on the locking members; and
a length that is at least about 3 inches, such that the central occluding portion is configured to span between two shrouded padlocks spaced apart on the latch by a distance of about by a distance in the range of about 1½ to 2 inches.

7. The locking assembly of claim 1, wherein the latch shield is formed from hardened metal.

8. The locking assembly of claim 1, wherein the at least one lock is a shrouded padlock.

9. A latch shield comprising:
an occluding member having a cross-section configured to substantially fill an opening in at least one lock when positioned in the opening along with locking members of a latch such that the locking members are occluded by the occluding member; and
a plurality of blocking members coupled to the occluding member, the blocking members being configured to be positioned outward of the at least one lock when the occluding member is positioned in the opening of the at least one lock, and the blocking members being shaped to restrict movement of the occluding member such that the occluding member cannot be removed from the opening when the at least one lock is locked.

10. The latch shield of claim 20, wherein the latch shield is a U-shaped bar.

11. The latch shield of claim 10, wherein the U-shaped bar includes a central occluding portion that forms the occluding member, two outward blocking portions that form the blocking members, and two connecting curves that connect the outward blocking portions to the central occluding portion.

12. The latch shield of claim 11, wherein the central occluding portion is a substantially straight length of tubular bar, and the blocking portions are substantially straight lengths of tubular bar that are substantially perpendicular to the central occluding portion.

13. The latch shield of claim 10, wherein the central occluding portion has:
a circular cross-section having a diameter of about 0.5 inches, such that the central occluding portion is configured to substantially fill a ⅞ semi-circular opening of a shrouded padlock when placed within the opening along with the locking members of the latch; and
a length that is at least about 3 inches, such that the central occluding portion is configured to span between two shrouded padlocks spaced apart on the latch by a distance in the range of about 1½ to 2 inches.

14. The latch shield of claim 10, wherein the latch shield is formed from hardened metal.

15. The latch shield of claim 14, wherein the latch shield is formed by extrusion, such that the latch shield is a single piece having a relatively uniform cross-section.

16. The latch shield of claim 9, wherein the occluding member has a hollow configured to mate with the locking members on the latch.

17. The latch shield of claim 9, wherein the occluding member is configured to cover a shackle on the lock.

18. The latch shield of claim 9, wherein the blocking member is a mass that is relatively larger than the opening in the lock, such that the blocking member cannot be passed through the opening.

19. The latch shield of claim 9, wherein the blocking member is one of a sphere, a block, or a star-shape.

20. The latch shield of claim 9, wherein the occluding member has a length configured to span a distance between at least two locks.
